(19) United States
(12) Patent Application Publication
(10) Pub. No.: US 2009/0218264 A1
(43) Pub. Date: Sep. 3, 2009

(54) Sewer System

(76) Inventors: David R. Hall, Provo, UT (US); Francis Leany, Salem, UT (US); Tyson J. Wilde, Spanish Fork, UT (US); Boyd Black, Provo, UT (US)

Correspondence Address: TYSON J. WILDE;NOVATEK INTERNATIONAL, INC., 2185 SOUTH LARSEN PARKWAY, PROVO, UT, 84606, US

(21) Appl. No.: 12/039,553

(22) Filed: Feb. 28, 2008

(51) Int. Cl. B01D 21/30

(52) U.S. Cl. 210/134

(57) ABSTRACT

In one aspect of the present invention, a system for the transportation of liquid and solid waste incorporated into a floor of a building has a generally horizontal pipe with a first and second end. A motor is disposed at the first end and an auger is disposed in and along at least a portion of a length of the pipe and is in communication with the motor. The auger is adapted to the transport of liquid and solid waste along the at least a portion of the length of the pipe.

### BACKGROUND OF THE INVENTION

The current invention relates to sewer systems. In some situations it is very difficult to drain and transport liquid and solid waste. Consequently, many efforts have been made to develop a more effective way to drain and transport liquid and solid waste.

U.S. Pat. No. 4,830,585 to Ruyle, which is herein incorporated by reference for all that it contains discloses a system for pumping a fluid of variable consistency into a fluid container. The system includes a vacuum power assist auger to withdraw fluid upwardly from a reservoir. A hose connecting an outlet end of the power assist auger to a fluid inlet at one end of a booster pump assembly is provided to supply fluid to the fluid inlet. A fluid outlet is provided at another end of the booster pump assembly. The fluid outlet is connected to a loading pipe so that the fluid is forced by the booster pump assembly through the fluid outlet and the loading pipe to the fluid container. A vacuum is created by the booster pump assembly in the hose so that fluid of a variable consistency may be withdrawn easily from the reservoir by the power assist auger and the booster pump assembly.

U.S. Pat. No. 2,795,193 to Linscott, which is herein incorporated by reference for all that it contains, discloses a sanitary sump pump device having a pump tube and an auger therein, said pump, tube and auger structure being made in sections for purposes of increasing and decreasing the material elevating distance of the pump, and coupling means for joining the pump tube elements, each to its succeeding section, means at the lower end of the lower pump tube section for revolvably supporting the auger section therein, and a single inwardly extending support arm carried by each pump tube coupling element for holding an antifriction bearing in a position centered on the center axis of the pump tube assembly, an antifriction bearing, said antifriction bearing being held in said holder therefore, the upper end of each pump tube section and its respective auger pump shaft end being revolvably carried in its respective antifriction bearing and extending thereabove, the upper extending auger pump shaft end being multisided, the lower end of the succeeding auger pump shaft section having socket thereon, said socket being multisided for receiving, and having the multisided end of the preceding auger pump shaft end fitted and seated therein.

U.S. Pat. No. 4,318,670 to Fechter et al., which is herein incorporated by reference for all it contains, discloses a pump for conveying waste water and the like embodying a substantially vertically arranged drivable screw mounted for rotation within a fixed pipe having an inlet at the lower and thereof and an outlet at the upper end thereof. At least one upstanding baffle is mounted below the screw and in the vicinity of the inlet with at least the upper portion of the baffle extending in the direction of conveyance.

### BRIEF SUMMARY OF THE INVENTION

In one aspect of the present invention, a sewer system for the transportation of liquid and solid waste incorporated into a floor of a building has a generally horizontal pipe with a first and second end. A motor is disposed at the first end and an auger is disposed in and along at least a portion of a length of the horizontal pipe and is in communication with the motor. The auger is adapted to the transport the liquid and solid waste along the at least a portion of the length of the horizontal pipe.

The auger may comprise a material selected from a group consisting of steel, aluminum, composite, rubber, plastic or combinations thereof. The auger may have at least one joint. The auger may have a thin layer protective coating. The thin layer protective coating may comprise titanium nitride. The auger may be adapted to clean an inside surface of the horizontal pipe. The auger may have a rubber blade. The system may have a plurality of augers. The different augers may rotate at different torques and/or speeds.

The system may be in electrical communication with a toilet. The system may be in electrical communication with a shower or tub drain. The system may be in electrical communication with a floor drain. The system may be in electrical communication with a washing machine, a dishwasher, a sink or combinations thereof. The system may have a plurality of horizontal pipes. The system may have a plurality of augers. The system may have a plurality of motors.

The motor may be activated by a sensor, a timer, a switch, or combinations thereof. The motor may be disposed within a protective generally water proof casing. The horizontal pipe may have at least one elbow. The sewer system may be in fluid communication with an anaerobic digester. At least one shared pipe connects generally horizontal pipes of at least two buildings.

In another aspect of the invention, a toilet comprises a bowl and a fluid pathway connected to a sewer system. An auger is disposed within the fluid pathway and the auger is adapted to suck the waste out of the bowl. The fluid pathway may comprise a siphon with a U-shaped portion. The auger may be disposed within the U-shaped portion or it may be disposed between the U-shaped portion and the bowl or the sewer system. In some embodiments, a digestion chemical is injected into the bowl or the sewer system when the auger is activated. The auger may be activated by pressing a button, pushing a handle or activating a motion sensor. The auger may be driven by an electric motor which may be disposed outside of the toilet.

### BRIEF DESCRIPTION OF THE DRAWINGS

FIG. 1 is a cross-sectional diagram of an embodiment a sewer system.

FIG. 1a is a cross-sectional diagram of another embodiment a sewer system.

FIG. 2 is a cross-sectional diagram of another embodiment of a sewer system.

FIG. 2a is a cross-sectional diagram of another embodiment of a sewer system.

FIG. 3 is a perspective diagram of an embodiment of an auger.

FIG. 4 is a cross-sectional diagram of another embodiment of a sewer system.

FIG. 5 is a cross-sectional diagram of another embodiment of a sewer system.

FIG. 6 is a cross-sectional diagram of another embodiment of a sewer system.

FIG. 7 is a cross-sectional diagram of another embodiment of a sewer system.

FIG. 8 is a cross-sectional diagram of another embodiment of a sewer system.

FIG. 9 is a cross-sectional diagram of an embodiment of a motor.

FIG. 10 is a cross-sectional diagram of another embodiment of a motor.

FIG. 11 is a cross-sectional diagram of another embodiment of a motor.

FIG. 11a is a cross-sectional diagram of another embodiment of a motor.

FIG. 12 is a cross-sectional diagram of another embodiment of a sewer system.

FIG. 13 is a cross-sectional diagram of another embodiment of a sewer system.

FIG. 14 is a cross-sectional diagram of another embodiment of a sewer system.

FIG. 15 is a cross-sectional diagram of another embodiment of a sewer system.

FIG. 16 is a cross-sectional diagram of another embodiment of a sewer system.

### DETAILED DESCRIPTION OF THE INVENTION AND THE PREFERRED EMBODIMENT

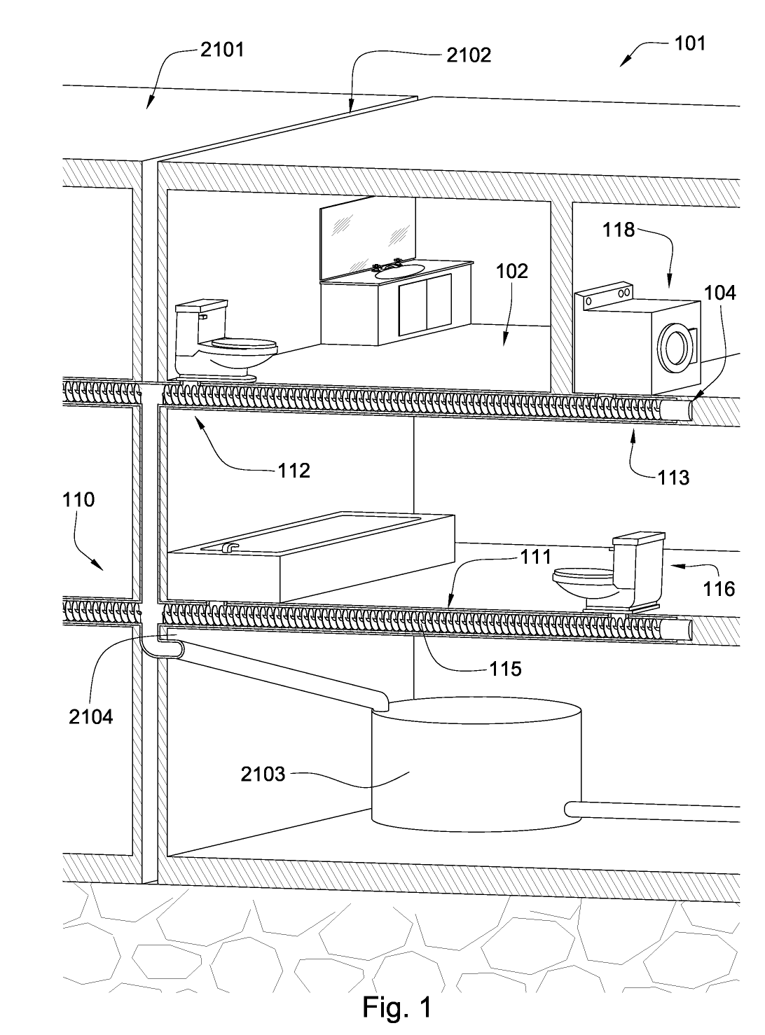

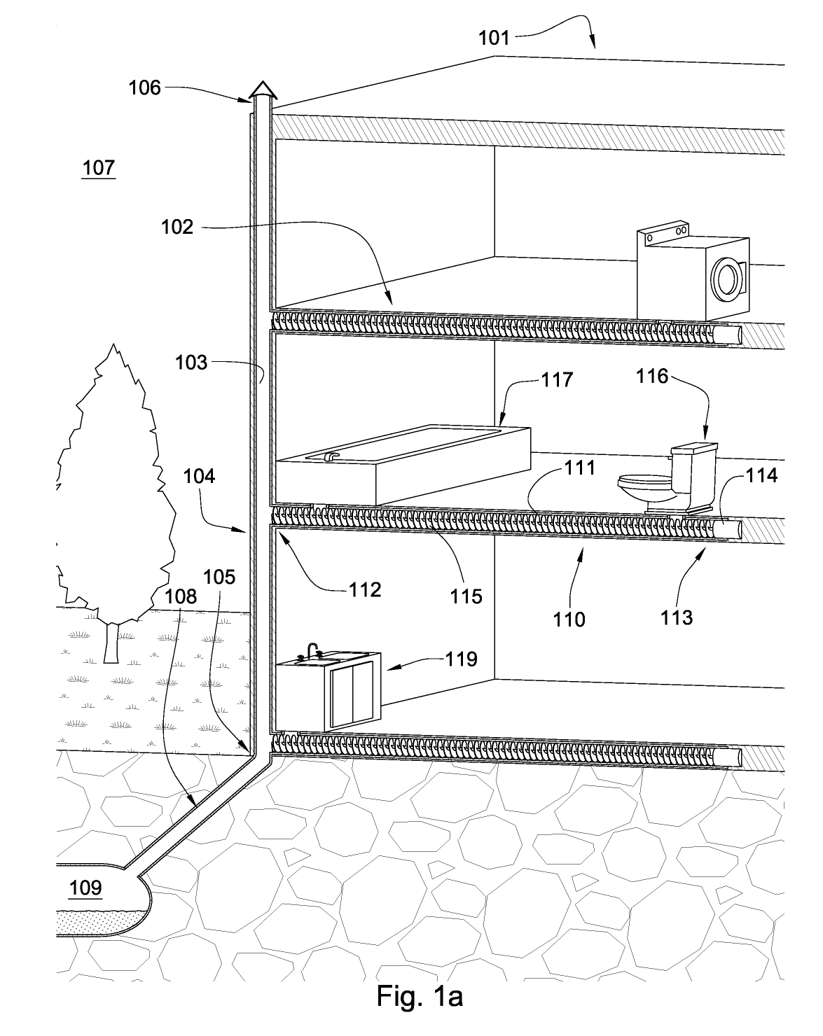

FIG. 1 is a diagram of an embodiment of the invention. A building 101 shares a sewer system 110 with an adjacent building 2101. Both buildings 101, 2101 are equipped with substantially horizontal pipes disposed within the floors and or ceilings and are in fluid communication with toilets 116, tubs, washing machines 118, dishwashers, sinks and other facilities that expel waste into the sewer system. An auger 115 in the horizontal pipes 111 moves sewage in a generally horizontal fashion within the floor from one end of the pipe to another end, where it is dumped into shared pipes 2104 located is a utility space 2102 between the buildings which direct the sewage to an anaerobic digester 2103. The anaerobic digester 2103 uses micro-organisms to break down the sewage and turn it into CO2, methane, and soil nutrients. Preferably the products of the anaerobic digester are re-used in the vicinity of the buildings such as in gardens or powering machines and vehicles. The auger 115 allows a horizontal pipe to be used in the sewer system which allows for thinner floors since traditionally the sewer system incorporate a sloped pipe or drain to transport the sewage. The thinner floors give more freedom to building designers and save on material costs.

FIG. 1a is a cross-sectional diagram of an embodiment of a building 101. The building 101 may comprise at least one floor 102 and at least one generally vertical vent pipe 103. The at least one generally vertical vent pipe 103 may be disposed within a wall 104 of the building 101. The at least one vent pipe 103 may comprise a drainage end 105 and a ventilation end 106. The ventilation end 106 of the vent pipe 103 may be open to the outside atmosphere 107. The drainage end 105 of the vent pipe 103 may be in communication with a sewer pipe 108. The sewer pipe 108 may have a downward slope and may drain into a sewer main 109 or a septic tank 109.

The building 101 may comprise at least one sewer system 110 for the transportation of liquid and solid waste 201 in the building 101. The system 110 may be incorporated into the floor 102 of the building 101. The system 110 comprises a generally horizontal pipe 111 comprising a first end 113 and a second end 112. The second end 112 of the horizontal pipe 111 may be in communication with the vent pipe 103. A motor 114 is disposed at the first end 113 of the horizontal pipe 111 and may be disposed within the floor 102. An auger 115 is disposed in and a long at least a portion of a length of the horizontal pipe 111 and is in communication with the motor 114.

The horizontal pipe 111 may be in physical communication with a toilet 116, a shower drain, a tub drain 117, a floor drain, a washing machine 118, a dishwasher, a sink 119, a garbage disposal, or combinations thereof. The horizontal pipe 111 may be in physical communication with any machine or appliance that may expel liquid and/or solid waste 201. As liquid and/or solid waste 201 enters the horizontal pipe 111 the motor 114 is initiated and actuates the auger 115. As the auger 115 is rotated it pushes the liquid and/or solid waste 201 across the length of the horizontal pipe 111 and into the vent pipe 103. The vent pipe 103 directs the liquid and/or solid waste 201 to the sewer pipe 108 which directs the liquid and/or solid waste 201 to the sewer main 109 or septic tank 109. Gases produced in the horizontal pipe 111 and/or the vent pipe 103 may escape to the outside atmosphere 107 via the ventilation end 106 of the vent pipe 103.

The auger 115 may comprise a material selected from a group consisting of steel, aluminum, composite, rubber, plastic or combinations thereof. The auger 115 may comprise a thin layer protective coating. The thin layer protective coating may comprise titanium nitride. It is believed that the thin layer protective coating may help prevent corrosion and wear on the auger 115.

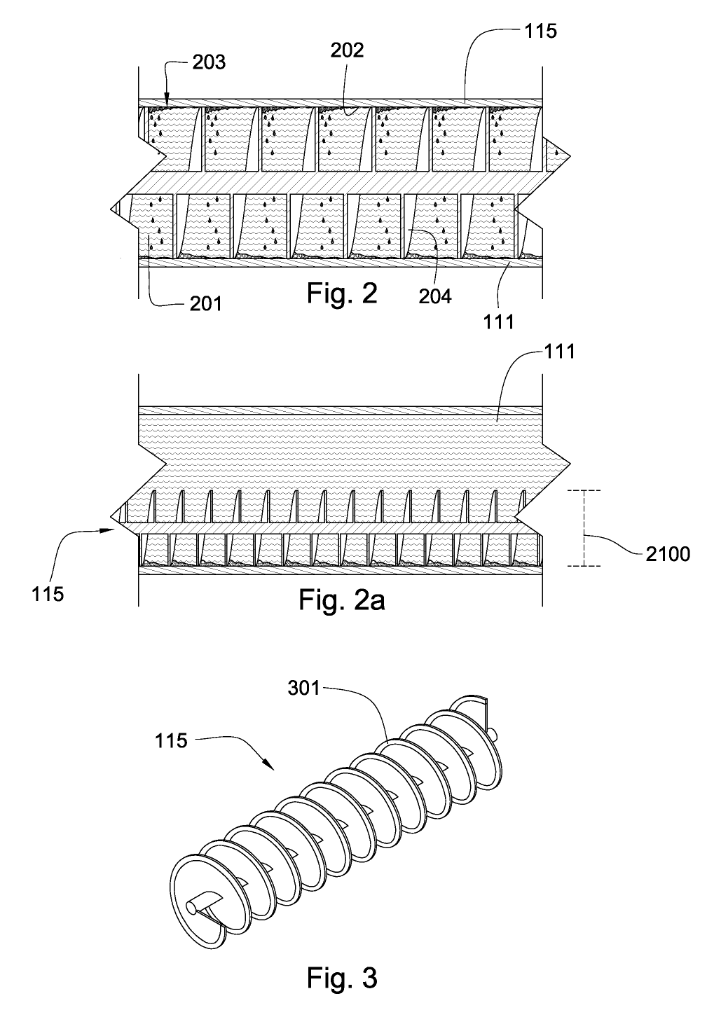

Referring now to FIGS. 2 through 3, the auger 115 may be adapted to clean an inside surface 202 of the horizontal pipe 111. It is believed that the auger 115 may prevent the horizontal pipe 111 from clogging by removing accumulated scum 203, mineral deposits, or other forms of build-up, from the inside surface 202 of the horizontal pipe 111 as the auger blade 204 scrapes the inside surface 202. The auger 115 may comprise a rubber blade 301. The rubber blade 301 made may be beneficial in that it would reduce friction between the auger 115 and the inside surface 202 of the horizontal pipe 111. The rubber blade 301 may also prove beneficial in that it may reduce the required tolerances when manufacturing the auger 115. In some embodiments, the auger 115 may comprise a smaller diameter 2100 than the horizontal pipe 111, such as shown in FIG. 2a.

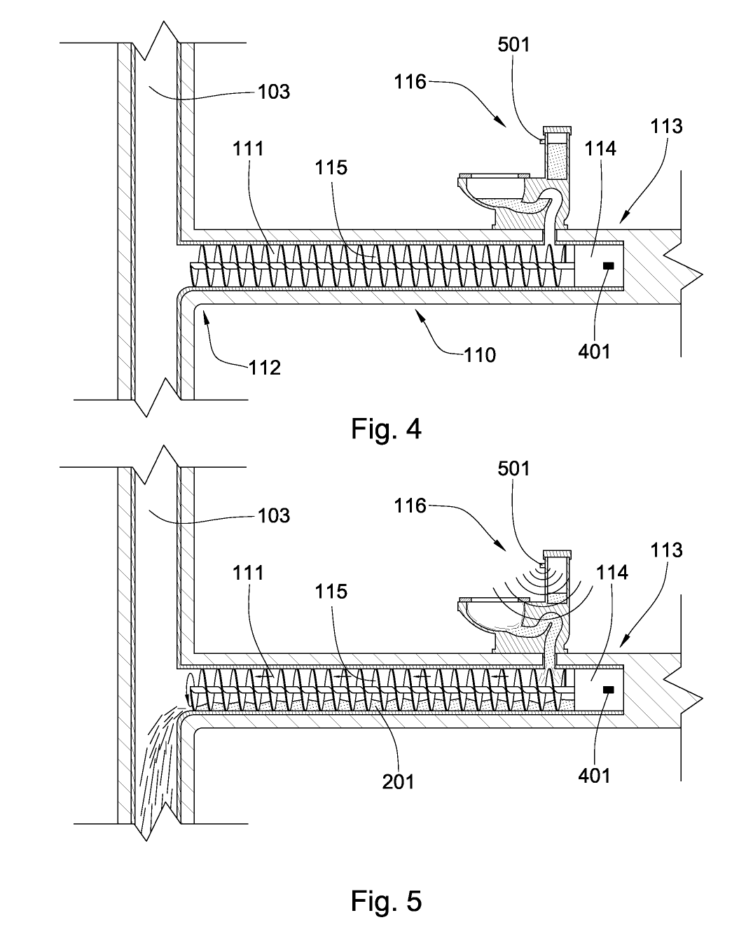

Referring now to FIGS. 4 through 5, the system 110 may be in electrical communication with the toilet 116. As the toilet 116 is flushed the toilet 116 communicates with the motor 114 activates it. The signal may be an electric, magnetic, wireless, Bluetooth, infrared, or chemical signal. Once the motor 114 is activated the auger 115 is actuated and the waste 201 is transported to the vent pipe 103. The toilet 116 may comprise a transmitter 501 that transmits a signal 502 when the toilet 116 is flushed. The motor 114 may comprise a receiver 401 adapted to receive the signal 502 from the transmitter 501. The signal 502 may be a wireless signal 502. The system 110 may also be in electrical communication with the shower drain, the tub drain 117, the floor drain a washing machine 118, the dishwasher, the sink 119, the garbage disposal, or combinations thereof. The system 110 may be in electrical communication with any machine or appliance that may expel liquid and/or solid waste 201. The motor 114 may also be activated by a sensor, a timer, a switch, or combinations thereof. In some embodiments, the motor has a pressure transducer, a moisture transducer, a chemical detector or combinations thereof to determine when liquid has been expelled into the horizontal pipe.

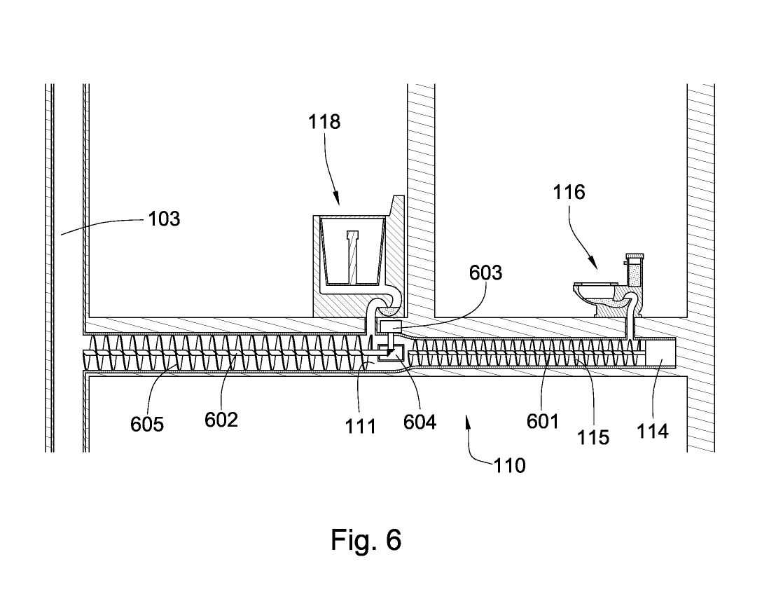

Referring to FIG. 6, the sewer system may comprise a first auger 601 and a second auger 602. The second auger 602 may have a wider diameter 605 than the first auger 601. The horizontal pipe 111 may widen in diameter so as to accommodate the wider diameter 605 of the second auger 602. The second auger 602 may be in communication with a second motor 603. A gearbox 604 may be disposed intermediated the second motor 603 and the second auger 602 and may transfer torque from the second motor 603 to the second auger 602. The second auger 602 may rotate at a different torque and or speed than the first auger 601. One auger may be required to push a heavier load than the other auger (such as when one auger is downstream of more devices adding waste into the system) and therefore may require more torque.

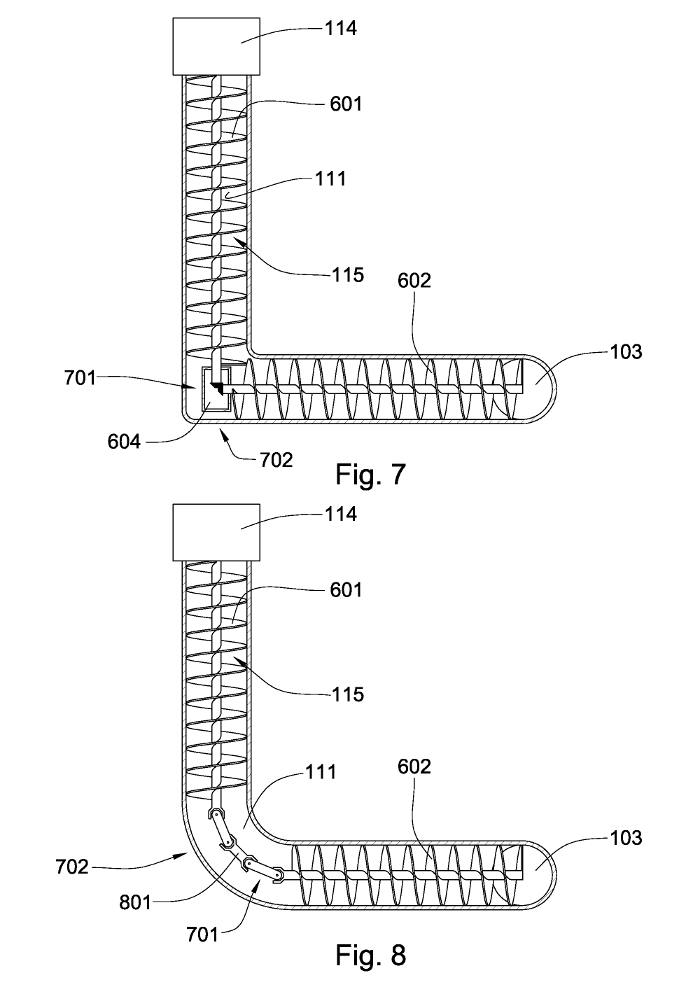

FIGS. 7 though 8 disclose embodiments wherein the horizontal pipe 111 may comprise at least one elbow 702. The auger 115 may comprise at least one joint 701. The joint 701 may comprise at least one gear box 604, or at least one U joint 801. The joint 701 may allow toque to be transferred in the auger 115 across and past the elbow 702.

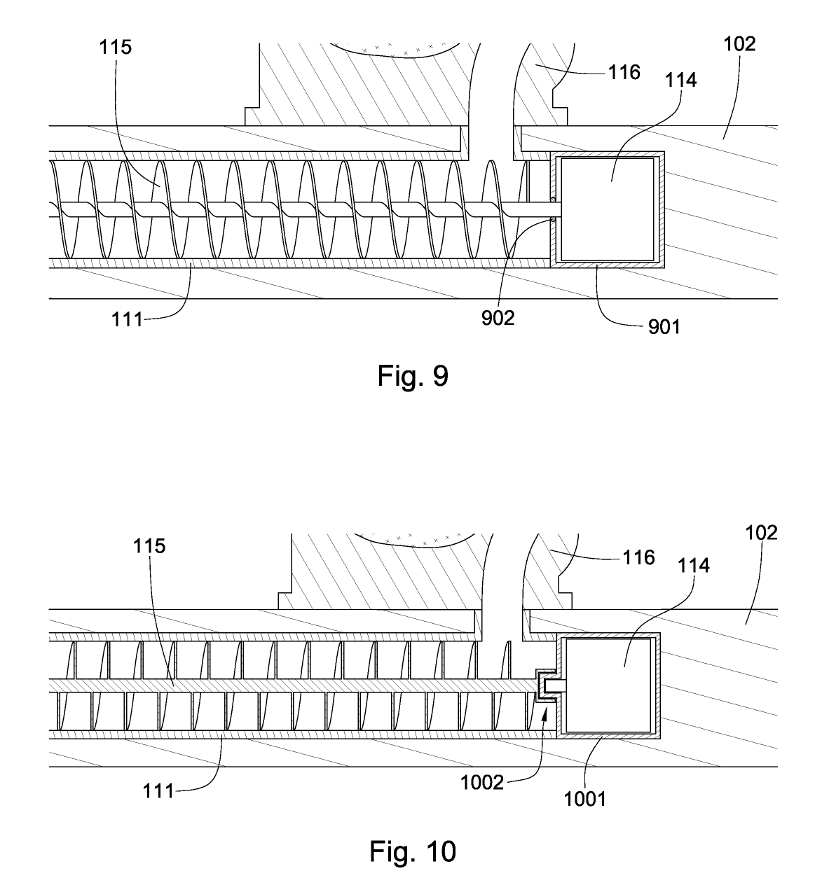

Referring now to FIGS. 9 though 11a, the motor 114 may be disposed within a protective generally water proof casing 901. An o-ring 902 may be disposed around the auger 115 or a motor shaft where the auger 115 or motor shaft passes through the generally water proof casing 901. The motor 114 may also be disposed within a hermetic casing 1001. The motor 114 may be in communication with the auger 115 via a magnetic coupling 1002 as shown in FIG. 10. The motor 114 may also be positioned within the floor 102 at an angle 1101 as shown in FIG. 11. The angle 1101 may range from 15 degrees to 85 degrees. The motor 114 may be in communication with the auger 115 via a U joint 801 such that the motor 114 may be able to transfer torque to the auger 115 even though the motor 114 may be positioned at an angle 1101. In the embodiment of FIG. 11a the motor is located outside of the toilet 116, but on the same floor. The auger 115 is made of a flexible material that allows the auger to bend around the corner while it is rotating.

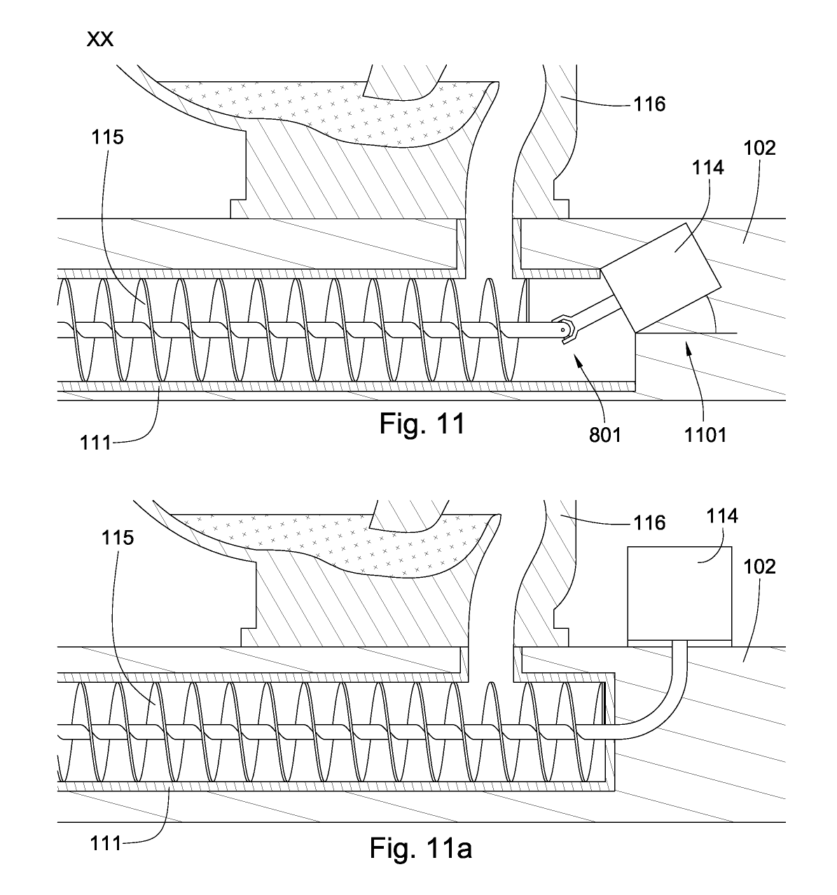

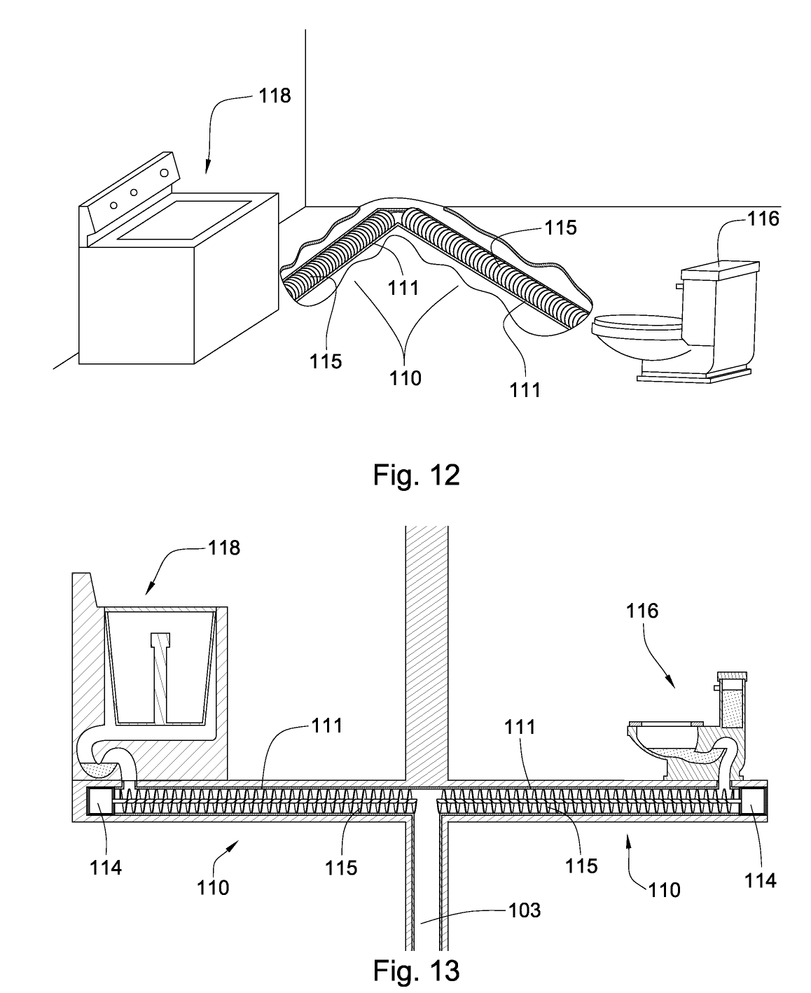

FIGS. 12 and 13 disclose an embodiment wherein the system 110 may comprise a plurality of horizontal pipes 111, a plurality of augers 115, and/or a plurality of motors 114. The plurality of motors 114, the plurality of augers 115 and the plurality of horizontal pipes 111 may be oriented such that one motor 114, one auger 115, and one horizontal pipe 111 are disposed opposite another motor 114, another auger 115 and another horizontal pipe 111 with both horizontal pipes 111 draining into the vent pipe 103.

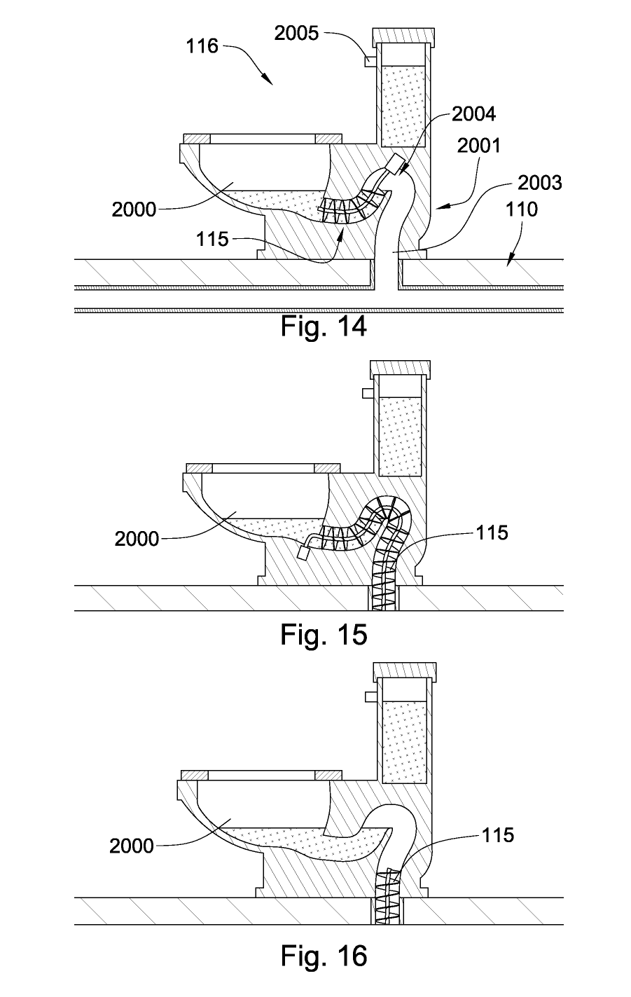

FIGS. 14-16 are cross-sectional diagrams of embodiments of a toilet 116. The toilet comprises a bowl 2000 and a fluid pathway 2001 connected to a sewer system 110. An auger 115 is disposed within the fluid pathway 2001 and the auger 115 is adapted to suck the waste out of the bowl 2000. The fluid pathway 2001 may comprise a siphon 2003 with a U-shaped portion 2004. The auger 115 is disposed within the fluid pathway 2001 between the U-shaped portion and the bowl 2002 in FIG. 14. In FIG. 15, the auger 115 is disposed within the U shaped portion 2004. The auger 115 may be made of a flexible material which allows it bend as it rotates around the U shaped portion 2004. FIG. 16 discloses the auger 115 between U-shaped portion 2004 and the sewer system 110.

The auger 115 may be activated by pressing a button, pushing a handle 2005 or activating a motion sensor. The auger 115 may be driven by an electric motor 114 which may be disposed outside of the toilet. In some embodiments, a digestion chemical may be injected when the auger 115 is activated. This allows the waste or sewage to begin to be broken up almost immediately after the waste is removed from the bowl of the toilet 116. The auger 115 may be driven by an electric motor, which may be disposed outside of the toilet 116 although in some embodiments the motor 114 may be incorporated into the toilet 116.

The auger described in FIGS. 1-13 may also be adapted to suck the waste out of the bowl of the toilet. Such a system has several advantages. Since the removal of the waste depends on the sucking motion of the auger, the amount of water traditionally used in flushing toilets is now no longer required. This saves water and reduces the noise of flushing. Also with this system, since the amount of water required is greatly reduced the sewage will be more concentrated allowing for easier digestion. In some embodiments, the sewage is brought directly into a digestion processor such as an anaerobic digestion system. The auger may also provide the benefit of breaking down the sewage while it is being transported to the processor which will speed up the digestion process. In some embodiments a digestion chemical will be injected into the sewage system, the fluid pathway or the bowl as the auger is activated to start the digestion process as early as possible.

In some aspects of the invention, a method for disposing of human waste comprises the step of sucking the waste out of a bowl of a toilet by activating an electrically controlled auger disposed in a fluid pathway connecting the bowl to a sewer system. The method may also include the step of injecting a digestion chemical into the bowl or sewer system when the auger is activated. The method may also include the step of activating the auger by pressing a button, pushing a handle or activating a motion sensor.

Whereas the present invention has been described in particular relation to the drawings attached hereto, it should be understood that other and further modifications apart from those shown or suggested herein, may be made within the scope and spirit of the present invention.

What is claimed is:

1. A sewer system for the transportation of liquid and solid waste incorporated into a floor of a building, comprising:
a generally horizontal pipe comprising a first and second end;
a motor disposed at the first end;
an auger disposed in and along at least a portion of a length of the horizontal pipe and is in communication with the motor; and
the auger adapted to the transport of liquid and solid waste along the at least a portion of the length of the horizontal pipe.

2. The system of claim 1, wherein the auger is adapted to clean an inside surface of the horizontal pipe.

3. The system of claim 1, wherein the system is in electrical communication with a toilet.

4. The system of claim 1, wherein the system is in electrical communication with a drain.

5. The system of claim 1, wherein the system is in electrical communication with a washing machine, a dishwasher, a sink or combinations thereof.

6. The system of claim 1, wherein the auger comprises a material selected from a group consisting of steel, aluminum, composite, rubber, plastic or combinations thereof.

7. The system of claim 1, wherein the horizontal pipe comprises at least one elbow.

8. The system of claim 1, wherein the auger comprises at least one joint.

9. The system of claim 1, wherein the system comprises a plurality of horizontal pipes.

10. The system of claim 1, wherein the system comprises a plurality of augers.

11. The system of claim 1, wherein the system comprises a plurality of motors.

12. The system of claim 1, wherein the auger comprises a rubber blade.

13. The system of claim 1, wherein the auger comprises a thin layer protective coating.

14. The system of claim 13, wherein the thin layer protective coating comprises titanium nitride.

15. The system of claim 1, wherein the auger comprises a first segment and a second segment.

16. The system of claim 15, wherein the second segment rotates at a different level of torque than the first segment.

17. The system of claim 1, wherein the motor is activated by a sensor, a timer, a switch, or combinations thereof.

18. The system of claim 1, wherein the motor is disposed within a protective generally water proof casing.

19. The system of claim 1, wherein the sewer system is in fluid communication with an anaerobic digester.

20. The system of claim 1, wherein at least one shared pipe connects generally horizontal pipes of at least two buildings.
